(19) United States
(12) Patent Application Publication
(10) Pub. No.: US 2001/0031339 A1
(43) Pub. Date: Oct. 18, 2001

(54) Bubble board

(76) Inventor: Bruce R. Johnson, Muskegon, MI (US)

Correspondence Address: LANNY M. ENGLUND, Mich 48304, Bloomfield Hills, MI, 48304, US

(21) Appl. No.: 09/844,550

(22) Filed: Apr. 28, 2001

Related U.S. Application Data
(60) Provisional application No. 60/200,668, filed on Apr. 28, 2000.

(51) Int. Cl. B32B 3/28

(52) U.S. Cl. 428/179

(57) ABSTRACT

A bubble board stock material for use in the packaging industry and other energy absorbing and impact protection applications. The bubble board stock material includes a generally planar surface with two or more surface sheets integrally connected with a plurality of geometrical shapes within a substrate to form the stock material. The plurality of geometrical shapes define protrusions extending out of the first sheet and complementary depressions in the second sheet uniformly spaced from one another in a repetitive pattern throughout the board stock material. The bubble board stock material also includes means for snapping and attaching a first board to a second board, and means for providing a flexible hinge allowing angular orientation and movement of one portion of the board stock material with another portion.

### CROSS-REFERENCES TO RELATED APPLICATIONS

(Ref) U.S. Provisional Patent Application Ser. No. 60/200,668 Filing Date-Apr. 28, 2000 Inventor-Bruce R. Johnson

### BACKGROUND OF THE INVENTION

1. Field of the Invention

The present invention relates to a stock material for use in the packaging industry with a variety of different applications requiring protection from impact forces including, but not limited to, guards for boat docks, bumpers, head protection restraints in automobiles, and many other variable energy-absorbing applications.

Various cushioning and energy-absorbing materials have been used to reduce injury form impact and to protect packaged members. These products can include card-board, rubber, cellular foams, dunnage, and air-inflated cushions used to reduce the energy transmission from impact or to impart some comfort factor, such as cushioning materials or mats. Typically, the absorbing material is a homogenius material of a predetermined thickness. For example, high density foams will absorb more energy than low-density foams, but are heavier, significantly more expensive, and more difficult to bend, shape, or contour with respect to the surfaces to be protected. Typically, compromises must be made between a higher-density material, which provides more resistance to deformation, while being inflexible with higher cost; and a lower-density material having less resistance to deformation, but of lower cost and more amenable to the contours of the contact surfaces of the material to be protected.

2. Description of the Related Art

The bubble board stock material as described by the patent applicant for the subject invention has novelity in multiple use applications not only in the packaging industry but in multiple and variable energy-absorbing applications not disclosed in the prior art.

The majority of the prior art is limited to laminated packaging materials with variable foam cores for making carton-like or container packages as well as insulation liners and other mailing and shipping container liners. The subject patent applicant's invention also has direct application in other applications to protect against impact forces as in bumper guards, automobile head restraints and other energy-absorbing applications not addressed by the prior art.

U.S. Pat. No. 3,861,994 issued to Stark teaches a laminated packaging material for making carton-like packages which consists of an immediate layer of polystyrene foam plastic having a fine cellular structure. Other common packaging insulation materials commonly used in mailing for package protection use one sheet of hemispherical protrusions formed on a common sheet covering the entire surface area. The subject patent application would meet and exceed the limitations of this prior art while offering far greater protection against impact in many more variable and severe energy-absorbing applications.

Other sheet packaging materials for providing impact protection include U.S. Pat. No. 4,086,384 by Adelman et al that teaches a “reinforced paper-microfoam sheet packaging material,” and another sheet packaging material also taught by Adelman in U.S. Pat. No. 4,584,225. Frisk et al discloses and claims in U.S. Pat. No. 4,994,310 “flexible packing laminate in the form of sheets or of a web.” No patents or other prior art was found that teaches the subject bubble board invention with two or more surface sheets integrally connected with a plurality of geometrical shapes within a substrate.

### F. BRIEF SUMMARY OF THE INVENTION

The bubble board stock material according to the present invention can be used in the packaging industry, as well as a variety of other uses where it is desirable to protect against impact forces, such as guards on boat docks, bumpers, head restraint protection in automobiles, and in other variable energy-absorbing applications. The bubble board stock according to the present invention includes two or more generally planar sheets having a plurality of geometrical shapes formed within a substrate therein. Preferably, the geometrical shape is defined in the form of an inverse bubble shape, where the outside of two inverse geometical shaped halves are welded, bonded, or integrally connected together to form a stock material. The stock material can be composed of recycled material, and can include any type of plastic, or recycled plastic, as a major consituent, and alternatively can include one or more lesser consituents as binders including sawdust, flyash, and other composites, and combinations thereof.

Each planar sheet of bubble board stock material further includes a first and second major surface opposite from one another. A plurality of geometrical shapes define protrusions extending out of the first surface and complementary depressions in the second surface. Preferably, the geometrical shapes are spaced uniformly from one another in a repetitive pattern. Also, and preferably, the geometrical shapes are identical to one another throughout at least a major area of the board, and preferably throughout at least a substantial area of the board. In the most preferred configuration, the geometrical shapes are identical to one another throughout the area of the board, excluding the geometrical shape's adjacent edge portions on opposite ends of the board. In the most preferred configuration, the geometrical shapes are formed as partial spheres, hemispheres, or bubbles.

In the most preferred configuration, a first sheet and a second sheet are connected to one another at an outermost portion of each protrusion, where the protrusions are in contact with one another. In the most preferred configuration, the protrusions adjacent one edge portion of the board are not in contact with one another as described in the following details. The opposite edge portion of the bubble board has a smaller geometrical shape size, such as a bubble having a smaller radius, to allow the board to be snapped together with a similar second board. The bubble board defined by the first and second sheets connected to one another, can also be cut to provide a “living hinge” allowing angular orientation of one portion of the board with respect another portion of the board. To form a “living hinge,” the first sheet is cut completely through while the second sheet is scored through only a portion of the thickness of the sheet in order to create the flexible hinge allowing movement of the first and second portions of the board with repect to one another.

Other objects, advantages and applications of the present invention will become apparent to those skilled in the art when the following description of the best mode contemplated for practicing the invention is related in the accompanying brief description of the drawings.

### G. BRIEF DESCRIPTION OF THE DRAWINGS

The description herein makes reference to the accompanying drawings wherein like reference numerals refer to like parts throughout the several view, and wherein:

FIG. 1 is a plan view of a bubble board according to the present invention;

FIG. 2 is a cross-sectional side view of the bubble board taken as shown in FIG. 1;

FIG. 3 is a detailed cross-sectional view of a snapped together joint of two bubble boards according to the present invention;

FIG. 4 is a detailed cross-sectional view of a first sheet connected to a second sheet to form the bubble board according to the present invention;

FIG. 5 is a cross-sectional view of a bubble board according to the present invention with a cut through the first sheet and a score partially through the thickness of the second sheet to define a “living hinge” according to the present invention; and

FIG. 6 is a cross-sectional view of a bubble board according to the present invention with the living hinge allowing pivotal movement of one portion of the bubble board with respect to another portion of the bubble board.

### H. DETAILED DESCRIPTION OF THE INVENTION

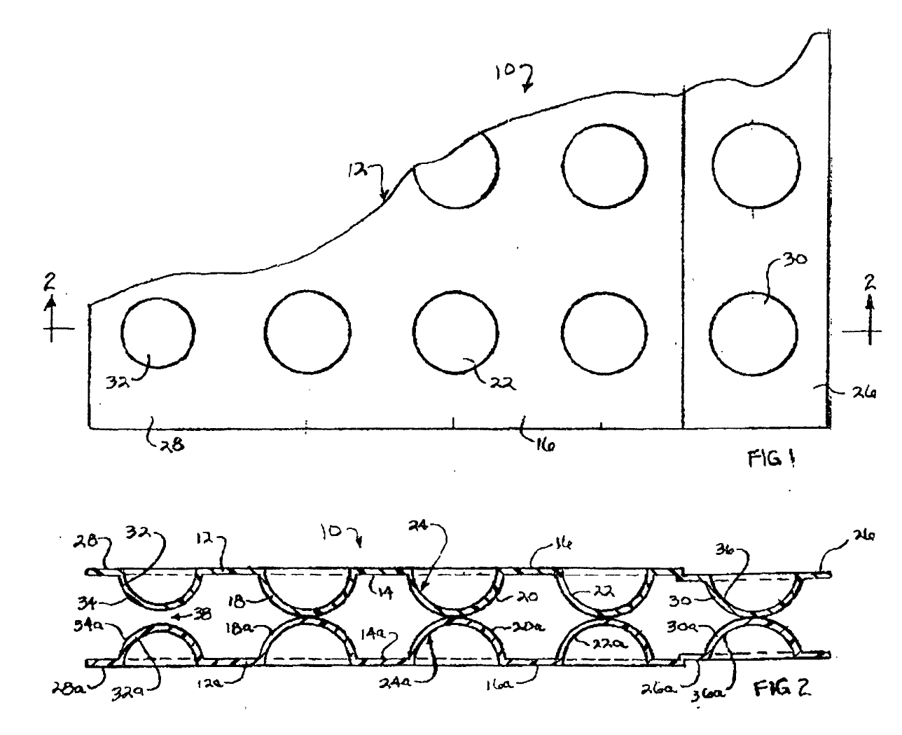

Referring now to FIGS. 1 and 2, a board stock material 10 is illustrated to be composed of sheet 12 of material having as a major constituent plastic, recycled plastic, polyamides, and/or combinations thereof. The material can also include lesser constitutent binders including sawdust, flyash, other composites, and/or combinations thereof. The material can be blended as desired for the particular structural strength and flexibility characteristics required for particular applications, and can be formed into sheets as described below of any desired size and thickness for the structural strength and flexibility characteristics required for a paticular application.

The sheet 12 includes a first major surface 14 and a second major surface 16 opposite from one another. A plurality of geometrical shapes 18 define protrusions 20 extending out of the first major surface 14 and corresponding, complementary depressions 22 formed in the second surface 16. Preferably, the geometrical shapes 18 are spaced uniformly form one another in a repetitive pattern across at least a majority of the surface of the sheet 12, and preferably across substantially the entire surface area of the sheet 12. In the preferred configuration, the geometrical shapes 18 are identical to one another thoughout a majority of the surface area of sheet 12, and preferably throughtout substantially the entire surface area of the sheet 12. The geometrical shapes 18 can be in any geometrical form that can be produced in the sheet 12. By way of example and not limitation, the geometrical shapes 18 can be in the form of rectangles, cylinders, cones upright polygons, spheres, heispheres, bubbles, or others. In the

preferred configuration, the plurality of geometrical shapes 18 are in the form of partial spheres, hemispheres, or bubbles 24.

Preferably, the board stock material 10 is formed by connecting a first sheet 12 to a second sheet 12a with the outside surface of two bubble halves 24, 24a respectively being connected together in any suitable fashion. By way of example and not limitation, the two outer surfaces of the bubble halves 24, 24a can be welded together, adhesively bonded together, thermally, chemically, or mechanically processed to structurally connect the first sheet 12 and second sheet 12a to one another at opposing raised surfaces 20, 20a contacting one another between the first sheet 12 and sheet 12a. Preferably, the processing of the first sheet 12 and second sheet 12a result in a board stock material 10 of unitary integral construction as best seen in FIG. 4.

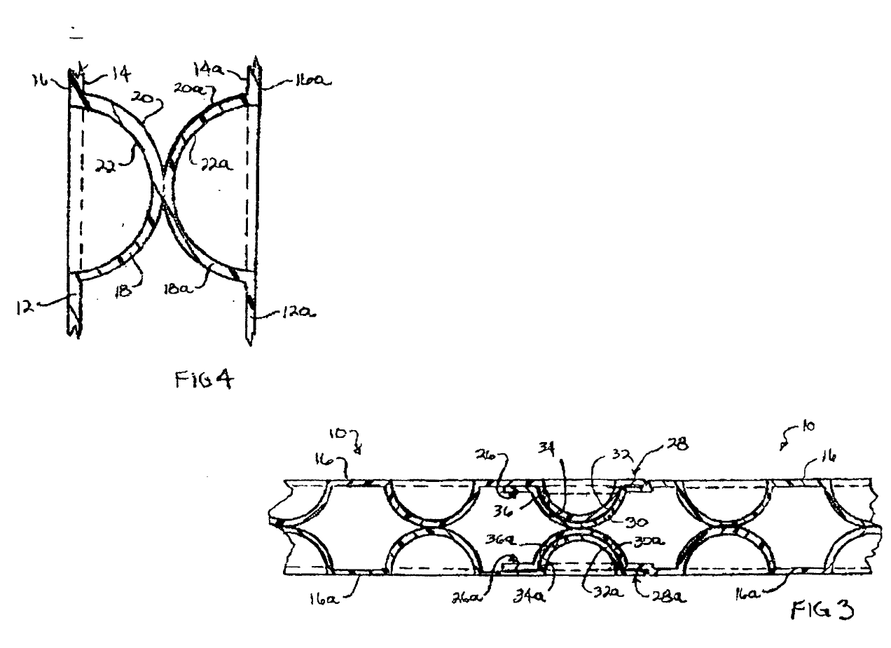

Referring now to FIGS. 1-3, in the preferred configuration of the stock material 10, the geometrical shapes 18 adjacent edge portions 26, 28 on the opposite ends of the sheet 12,12a include geometrical shapes 30, or 32 of different sizes. The geometrical shapes 30, 32 along opposite edge portions 26, 28 of the board stock material 10 are complementary to one another. As best seen in FIG. 2, one edge portion 26, 26a is slightly recessed from the major surface 16,16a reducing the size of the geometical shape 30, 30a formed along the edge portions 26, 26a of the first sheet 12 and second sheet 12a respectively. The opposite edge portion 28, 28a of the first sheet 12 and second sheet 12a respectively includes geometrical shapes 32 of reduced dimension to fit the outer surface 34, 34a into the complementary inner surface 36, 36a of the corresponding edge portion 26, 26a of an adjacent board stock material 10 to snap fit the edge portions of the adjacent stock material 10 to one another as best seen in FIG. 3. Referring again to FIG. 2, preferably the reduced dimension geometrical shapes 32, 32a do not protrude outwardly from the first surface 14, 14a a sufficient distance to come in contact with one another, and therefore are not connected to one another at the opposing surfaces 34, 34a. The gap 38 defined between the spaced surfaces 34, 34a of the opposing reduced dimension geometrical shapes 32, 32a allow the sheets 12, 12a to be flexed with respect to one another in order to insert the opposing edge portion 26, 26a of an adjacent bubble board for snap fit of the joint connection together.

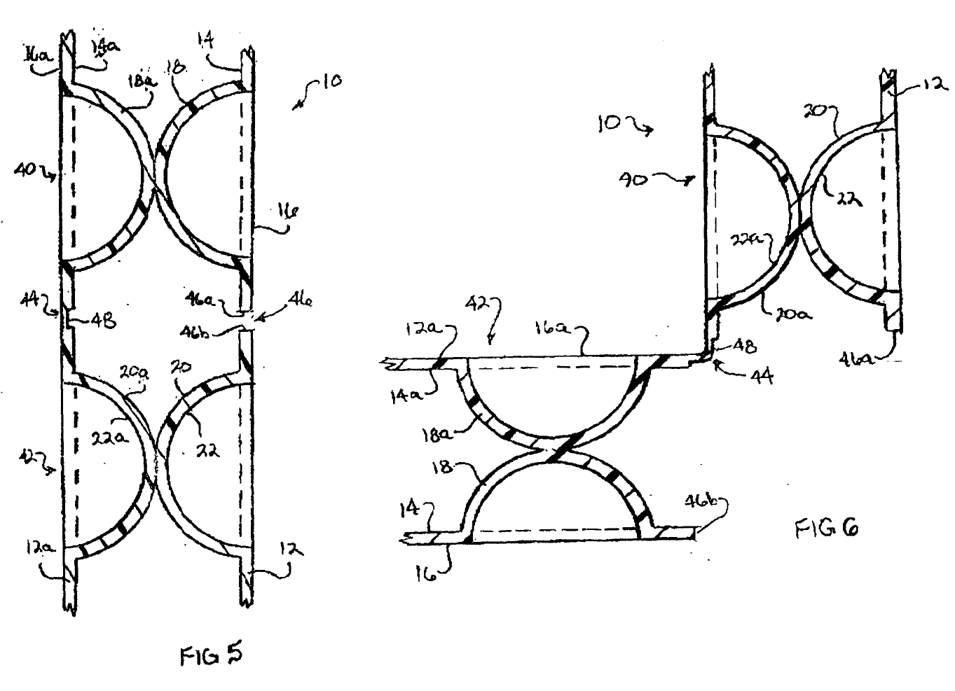

Referring now to FIGS. 5 and 6, the board stock material 10 can be processed to form a “living hinge” 44 to allow a first portion 40 to be disposed at an angular orientation with respect to a second portion 42. To form the “living hinge” 44, the board stock material 10 can be subjected to a cutting operation to form a cut or slot 46 through one sheet 12 defined by sidewalls 46a and 46b and to score a groove 48 partially through the thickness of the other sheet 12a. The remaining material left in the scored sheet 12a provides a flexible “living hinge” 44 allowing the first portion 40 to be rotated about the hinge axis with respect to the second portion 42 into any desired angular orientation.

It is expected that the material used to for the stock material 10 can blended composites, as required for the desired stength and flexibility of the stock material to be formed. In addition, it is expected that the thickness of the sheet material 12, 12a can be varied as desired to achieve the required strength and flexibility for particular applications. While it is expected that most applications can be satisfied with sheets of material of the same composition and thickness, it should be recognized that the present invention encompasses sheet materials blended from different compositions for different strength and flexibility characteristics, as well as sheets of different thicknesses, or any combination thereof.

In summary, a board stock material is disclosed comprising two or more sheets of material with first and second major surfaces opposite from one another, and a plurality of geometrical shapes defining protrusions extending out of the first major surface, and complementary depressions in the second major surface. In the preferred configuration, a first sheet with a predetermined thickness of a first material composition, and a second sheet of a second predetermined thickness of a second material composition are connected to one another at an outermost portion of each protrusion, where the protrusions are in contact with one another when the first major surfaces of each sheet are disposed facing on another.

While the invention has been described in connection with what is presently considered to be the most practical and preferred embodiment, it is to be understood that the invention is not to be limited to the disclosed embodiments but, on the contrary, is intended to cover additional and various modification configurations and equivalent arrangements included within the spirit and scope of the claims, which scope is to be accorded the broadest interpretation so as to encompass all such modification and equivalent structures as is permitted under the law.

I claim:

1. A bubble board stock material for providing impact protection in the packaging industry comprising:
(a) a generally planar surface with a substrate having a plurality of geometrical shapes integrally connected to form the board stock material;
(b) said bubble board stock material has first and second sheets with a first major surface and a second major surface opposite from one another and integrally connected with said plurality of geometrical shapes within said substrate;
(c) said plurality of geometrical shapes define protrusions extending out of the first sheet and complementary depressions in the second sheet;
(d) said plurality of geometrical shapes are uniformly spaced from one another in a repetitive pattern; and
(e) said plurality of geometrical shapes are identical to one another throughout a substantial area of the board stock material.

2. The bubble board stock material as recited in claim 1, wherein the plurality of geometrical shapes are identical to one another throughout the entire area of the board and the plurality of geometrical shapes are formed as hemispheres defining bubbles.

3. The bubble board stock material as recited in claim 1, wherein the first and second major surface sheets of the board are connected to one another at an outermost portion of each protrusion and wherein the protrusions are in contact with one another.

4. The bubble board stock material as recited in claim 1, wherein the first sheet is disposed with a predetermined thickness of a first material composition, and wherein the second sheet is disposed of a second predetermined thickness of a second material composition and the sheets are connected to one another at an outermost portion of each protrusion, and wherein the protrusions are in contact with one another when the first major surfaces of each sheet are disposed facing another.

5. The bubble board stock material as recited in claim 1, wherein means for snapping a first board to a second board is provided by an opposite edge portion of the first bubble board having a smaller geometrical shape size and corresponding bubble with a smaller radius than the edge portion of the second bubble board thus enabling the first bubble board to be snapped together with the similar second bubble board.

6. The bubble board stock material as recited in claim 1, wherein the first and second sheets connected by said plurality of geometrical shapes can also be cut to provide a flexible hinge allowing angular orientation and movement of one portion of the board with another portion of the board.
